(19) United States
(12) Patent Application Publication
(10) Pub. No.: US 2024/0180080 A1
(43) Pub. Date: Jun. 6, 2024

(54) GROUNDS MAINTENANCE VEHICLE WITH REMOTE OR AUTOMATIC OPERATOR SUSPENSION ADJUSTMENT

(71) Applicant: THE TORO COMPANY, Bloomington, MN (US)

(72) Inventors: Derek S. Duchscherer, Eden Prairie, MN (US); Chris A. Wadzinski, Inver Grove Heights, MN (US)

(21) Appl. No.: 18/524,310

(22) Filed: Nov. 30, 2023

Related U.S. Application Data
(60) Provisional application No. 63/539,741, filed on Sep. 21, 2023.
(60) Provisional application No. 63/429,496, filed on Dec. 1, 2022.

(51) Int. Cl. A01D 67/04; A01D 34/82

(52) U.S. Cl. CPC A01D 67/04; A01D 34/824; A01D 2101/00

(57) ABSTRACT

A grounds maintenance vehicle including a chassis, a support platform, at least one hand control, a suspension system, a load sensor, and a controller. The chassis includes a front end, a rear end, and a longitudinal axis extending therebetween. The support platform extends along the longitudinal axis. The at least one hand control is carried by the support platform and configured to control at least one of propulsion and steering of the vehicle. The suspension system includes a first suspension apparatus operatively acting between the chassis and the support platform and an actuator configured to adjust a preload applied to the one or more springs. The load sensor is configured to measure a weight applied to the support platform. The controller is operatively coupled to the actuator and configured to adjust the actuator to modify the preload based on the weight measured by the load sensor.

The present application claims priority to and/or the benefit of U.S. Provisional Patent Application No. 63/429,496, filed 1 Dec. 2022, and also claims priority to and/or the benefit of U.S. Provisional Patent Application No. 63/539,741, filed 21 Sep. 2023, each of which is incorporated herein by reference in its entirety.

Embodiments of the present disclosure are directed generally to riding grounds maintenance vehicles (e.g., turf care vehicles such as lawn mowers) having an adjustable suspension system.

Operators of grounds maintenance vehicles, such as zero-turn-radius (ZTR) mowers, often operate the vehicle for extended periods of time. Accordingly, mowers incorporating some type of suspension system have become more common in recent years. However, there may be a variety of different operator preferences and profiles to produce desirable specific suspension system characteristics (e.g., stiffness/spring rate and dampening). Further, even the same operator may wish to adjust these characteristics over time (or even over the course of a single workday).

While configurations vary, some known suspension systems are complex and ill-suited to providing the variability in spring rate and/or dampening characteristics needed to satisfy a wide range of operators and terrain types. Moreover, some of these suspension systems are complicated, which may not only increase the cost of manufacture, but may require correspondingly complicated repairs and/or maintenance.

### SUMMARY

Embodiments described herein may provide a grounds maintenance vehicle including a chassis, a support platform, at least one hand control, a suspension system, a load sensor, and a controller. The chassis may include a front end, a rear end, and a longitudinal axis extending between the front and rear ends. The support platform may extend along the longitudinal axis. The at least one hand control may be carried by the support platform and may be configured to control at least one of propulsion and steering of the vehicle. The suspension system may include a first suspension apparatus and an actuator. The first suspension apparatus may operatively act between the chassis and the support platform. The first suspension apparatus may include one or more springs. The one or more springs may be configured to elastically deflect when the support platform is displaced relative to the chassis. The actuator may be configured to adjust a preload applied to the one or more springs. The load sensor may be configured to measure a weight applied to the support platform. The controller may be operatively coupled to the actuator and may be configured to adjust the actuator to modify the preload based on the weight measured by the load sensor.

In another embodiment, a grounds maintenance vehicle may be provided that includes a chassis, a support platform, at least one hand control, a suspension system, and a controller. The chassis may include a front end, a rear end, and a longitudinal axis extending between the front and rear ends. The support platform may extend along the longitudinal axis. The support platform may be positioned at an operating position under operator load. The at least one hand control may be carried by the support platform and may be configured to control at least one of propulsion and steering of the vehicle. The suspension system may include a first suspension apparatus and an actuator. The first suspension apparatus may operatively act between the chassis and the support platform. The first suspension apparatus may include one or more springs. The one or more springs may be configured to elastically deflect when the support platform is displaced relative to the chassis. The actuator may be configured to adjust a preload applied to the one or more springs. The controller may be operatively coupled to the actuator and may be configured to move the actuator to adjust the preload to maintain the operating position of the support platform within a range of travel.

Embodiments described herein may provide a grounds maintenance vehicle including a chassis, a support platform, and a suspension system. The chassis may include a front end, a rear end, and a longitudinal axis extending between the front and rear ends. The support platform may extend along the longitudinal axis. The suspension system may include a first suspension apparatus and an actuator. The first suspension apparatus may be operatively acting between the chassis and the support platform. The first suspension apparatus may include one or more springs. The one or more springs may be configured to elastically deflect when the support platform is displaced relative to the chassis. The actuator may be configured to adjust a preload applied to the one or more springs. The vehicle may also include a load sensor configured to measure a weight applied to the support platform and a controller operatively coupled to the actuator. The controller may be configured to move the actuator to adjust the preload based on one or more parameters including the measured weight via the load sensor.

In another embodiment, a grounds maintenance vehicle may be provided that includes a chassis, a support platform, and a suspension system. The chassis may include a front end, a rear end, and a longitudinal axis extending between the front and rear ends. The support platform may extend along the longitudinal axis. The support platform may include a seat support portion. The suspension system may include a first suspension apparatus and an actuator. The first suspension apparatus may be operatively acting between the chassis and the seat support portion of the support platform. The first suspension apparatus may include one or more springs. The one or more springs may be configured to elastically deflect when the support platform is displaced relative to the chassis. The actuator may be configured to adjust a preload applied to the one or more springs. The vehicle may also include a control input operatively connected to, and spaced a distance from, the actuator. The control input may be configured to be manipulated by an operator to move the actuator.

In yet another embodiment, a riding lawn mower may be provided that includes a chassis, a support platform, and a suspension system. The chassis may include a front end, a rear end, and a longitudinal axis extending between the front and rear ends. The support platform may extend along the longitudinal axis and may be positioned at an operating position under operator load. The suspension system may include a first suspension apparatus and an actuator. The first suspension apparatus may be operatively acting between the chassis and the support platform. The first suspension apparatus may include one or more springs. The one or more springs may be configured to elastically deflect when the support platform is displaced relative to the chassis. The actuator may be configured to adjust a preload applied to the one or more springs. The vehicle may also include a controller operatively coupled to the actuator and configured to move the actuator to adjust the preload such that the operating position of the support platform is substantially maintained within a path of travel.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 illustrates a grounds maintenance vehicle, e.g., riding lawn mower, incorporating an adjustable suspension system in accordance with embodiments of the present disclosure;

FIG. 2 is a partial perspective view of the mower of FIG. 1 illustrating portions of the illustrative suspension system;

FIG. 3A is another partial top perspective view of the mower of FIG. 1 with components (e.g., the seat and seat frame) shown exploded from a support platform of the mower;

FIG. 3B is a bottom perspective view of the mower of FIG. 3A;

FIG. 4 is a view similar to FIG. 2, but with a support platform removed to better illustrate aspects of the illustrative suspension system;

FIG. 5 is an enlarged partial perspective view of a portion (e.g., first suspension apparatus) of the suspension system of FIGS. 1-4;

FIG. 6 is a torsion spring that forms an illustrative biasing element of the first suspension apparatus;

FIG. 7 is a section view taken along line 7-7 of FIG. 5 illustrating the suspension system when the support platform is unloaded and a preload adjustment mechanism of the system is set for a minimal (“least-stiff”) preload of the biasing elements;

FIG. 8 is a bottom perspective view of portions of an illustrative suspension system in isolation;

FIG. 9A is a side perspective view of an actuator of the suspension system in accordance with embodiments of the present disclosure, the actuator is configured to alter the preload of biasing elements of the suspension system;

FIG. 9B is a section view of suspension system positioned between the chassis and the support platform;

FIG. 10 is a section view similar to FIG. 7 (i.e., the support platform shown unloaded), but with the actuator set to provide an intermediate preload to the biasing elements;

FIG. 11 is a section view of a suspension system in accordance with another embodiment of the present disclosure;

FIG. 12A is a rear perspective of a mower including a suspension system in accordance with yet another embodiment of the present disclosure and including a single actuator; and

FIG. 12B is a rear perspective of a mower including a suspension system in accordance with yet another embodiment of the present disclosure and including two actuators.

FIG. 13 is a schematic of a mower including a suspension system and at least one hand control in accordance with any embodiments disclosed herein.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est, and means “that is.” “E.g.” is used as an abbreviation for the Latin phrase exempli gratia, and means “for example.”

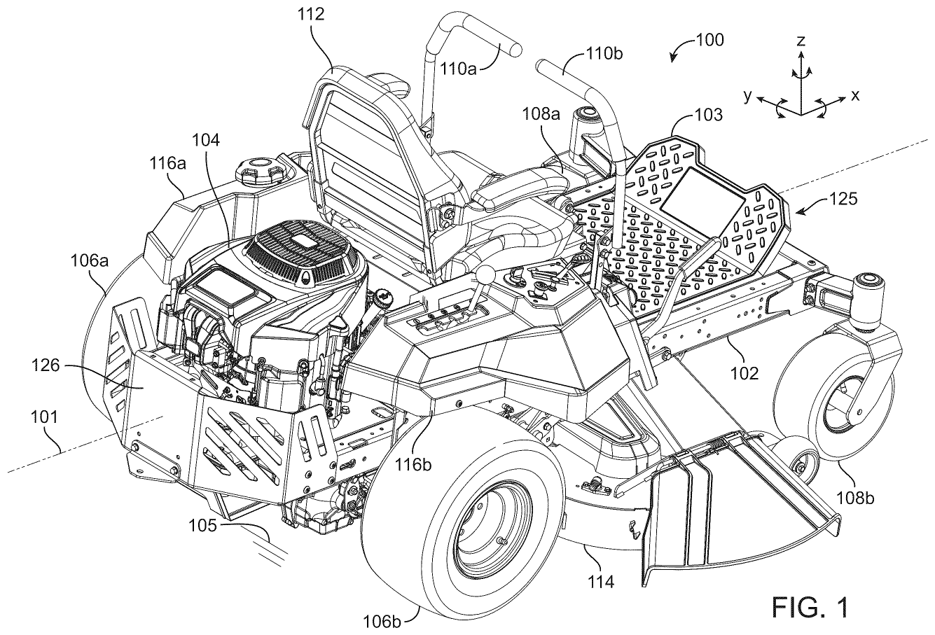

It is noted that the terms “comprises” and variations thereof do not have a limiting meaning where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the vehicle 100 (e.g., mower of FIG. 1) while it is in an operating configuration, e.g., while the vehicle 100 is positioned such that wheels 106 and 108 rest upon a generally horizontal ground surface 105. These terms are used only to simplify the description, however, and not to limit the interpretation of any embodiment described.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

While various embodiments are possible within the scope of this disclosure, some embodiments are directed to grounds maintenance vehicles that include a chassis supported by one or more ground contact members. The vehicle also includes an operator support platform adapted to support a riding operator, and a suspension system operatively acting between the chassis and the support platform. The suspension system may attenuate forces, e.g., travel-induced forces, which may otherwise be transmitted to the support platform during vehicle operation. Stated another way, the support platform, and thus the operator, may be partially isolated from forces imparted to the chassis as a result of vehicle operation. Moreover, in some embodiments, the suspension system may permit adjustment of spring rate and/or dampening of the suspension system to, for example, better accommodate a range of operator riding preferences. Some embodiments may provide a single adjuster or actuator that alters the spring rate and/or dampening characteristics of multiple suspensions units simultaneously. Such a configuration may be beneficial when, for example, symmetric adjustment of multiple suspension units is desired.

Still further, the illustrative suspension systems may be remotely or automatically adjusted. For example, in one or more embodiments, the suspension system may include an actuator that alters the suspension apparatus at the push of a switch or button. Further, for example, in one or more embodiments, the suspension system may automatically adjust based on input parameters of the operator (e.g., measured or input) to provide an optimal ride (that can be further micro-adjusted) according to a specific operator.

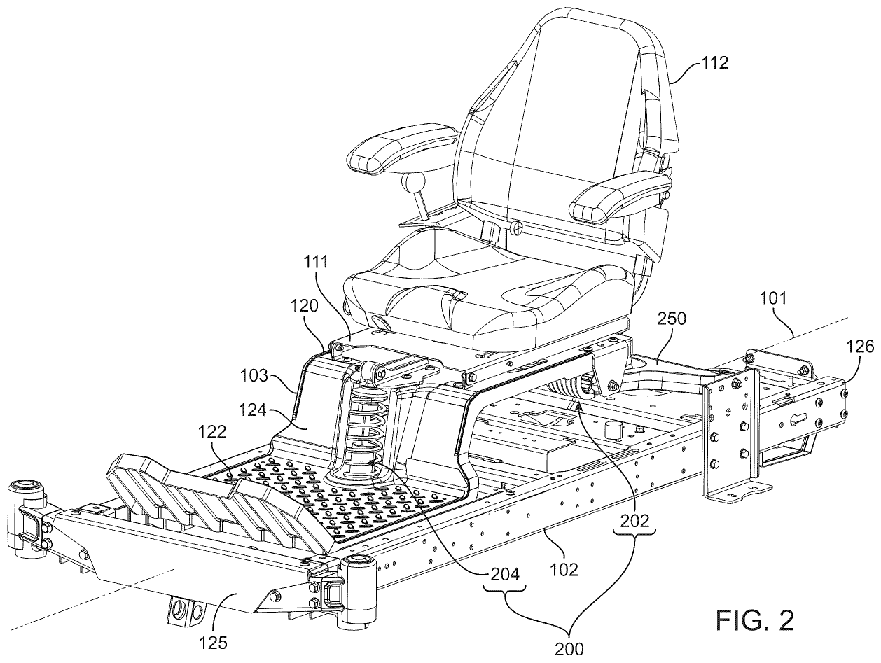

FIG. 1 illustrates an illustrative grounds maintenance vehicle 100 that incorporates a suspension system 200 (see FIG. 2) in accordance with embodiments of the present disclosure. As stated above, the suspension system 200 may operatively connect a chassis 102 of the vehicle with an operator support platform 103. As a result, the support platform 103 may “float” relative to the chassis 102 via compliance of the suspension system 200. That is, the suspension system 200 may allow for relative motion between the support platform 103 and the chassis 102. Further, the support platform 103 may be configured to support not only a seat of an operator, but also the operator's hands and feet, e.g., the operator is fully supported by the support platform 103. For example, the support platform 103 (rather than the chassis 102) may support and/or carry at least one hand control 110a, 110b (individually or collectively referred to as hand control(s) 110).

While the vehicle is shown and described herein as a self-propelled ride-on lawn mower (also referred to herein simply as a “mower” or “vehicle”), such a configuration is not limiting. That is, those of skill in the art will realize that embodiments of the present disclosure may find application to other types of ride-on (e.g., sit-on or stand-on) grounds maintenance vehicles including skid-steer vehicles, aerators, material spreader/sprayers, dethatchers, snow throwers, and debris management systems, to name a few.

As shown in FIG. 1, the vehicle 100/chassis 102 may define front and rear ends 125, 126, respectively, with a longitudinal or travel axis 101 extending between the front and rear ends (i.e., the longitudinal axis being the axis of mower travel when the mower is traveling in a straight line). The support platform 103 may extend along the longitudinal axis 101. As used herein, a transverse axis or plane is any laterally extending axis or plane that is normal to the longitudinal axis 101.

The chassis 102 may support a prime mover (e.g., electric motor(s) and/or internal combustion engine 104), which may, in one embodiment, be located at or near the rear end 126 of the vehicle 100. Left and right ground-engaging drive members (e.g., rear drive wheels 106a, 106b) may be coupled to left and right sides, respectively, of the chassis 102. Each drive wheel may be powered to rotate, relative to the chassis 102, about an axis such that simultaneous and equal rotation of the two drive wheels causes the vehicle 100 to move parallel to (i.e., along) the longitudinal axis 101. In some embodiments, the vehicle 100 may be configured as a ZTR vehicle, wherein the drive wheels 106 are independently driven by the engine 104 (e.g., via one or more hydraulic motors/pumps, hydrostatic transmissions, or the equivalent). While described herein as an internal combustion engine 104, other embodiments could utilize other prime movers, e.g., an electrical motor, to power the drive wheels 106, or utilize separate prime movers for propulsion and for implement (cutting deck) power. Moreover, while illustrated as wheels 106, other embodiments may utilize other drive members (e.g., tracks or the like) without departing from the scope of this disclosure.

The vehicle 100 may additionally include one or more, e.g., two, support members or wheels 108a, 108b. In the illustrated embodiment, the support wheels 108 are caster wheels and are located forward of the drive wheels 106 (e.g., during normal forward travel of the mower) and are thus referred to herein simply as “front” wheels. Together, the wheels 106 and 108 support the vehicle 100 in rolling engagement with the ground surface 105. While described herein as utilizing two rear drive wheels and two front castering wheels, such a configuration is merely exemplary. For example, other embodiments may use more or less wheels (e.g., a tri-wheel configuration), while still other embodiments may provide different drive wheel configurations (e.g., front-wheel drive or all-wheel drive) or different steering configurations (e.g., a vehicle with conventional Ackermann-type steering).

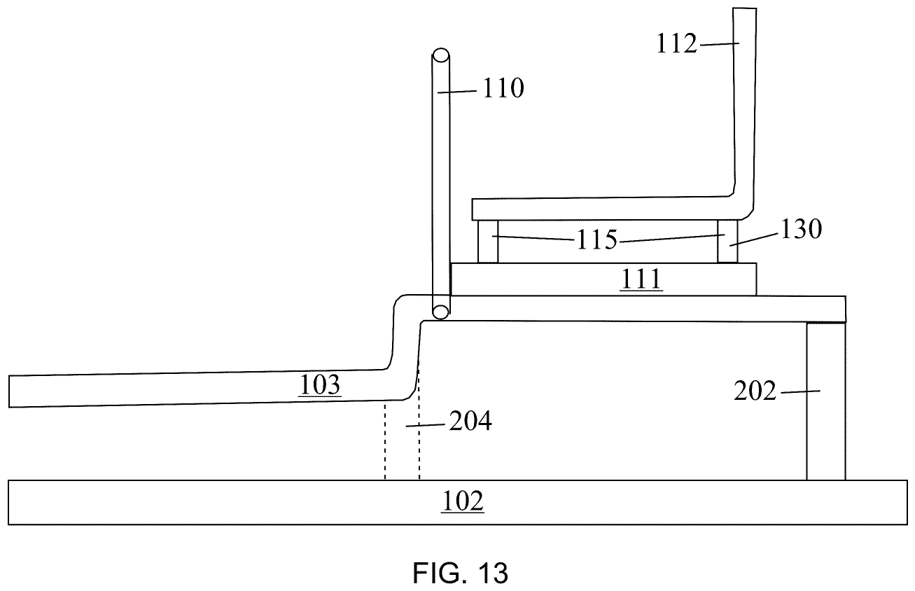

The vehicle 100 may further include one or more controls, e.g., the at least one hand control illustrated as left and right hand controls 110a, 110b. The hand control 110 may be carried directly by the chassis 102 or, as stated above, by the support platform 103 (as diagrammatically illustrated in FIG. 13). The at least one hand control 110 may be configured to control at least one of propulsion and steering of the vehicle 100. For example, the hand control (s) 110 may be configured as levers pivotally coupled to the vehicle 100 (e.g., to the support platform 103 or to the chassis 102) such that the levers may independently pivot forwardly and rearwardly (e.g., about a transverse axis) under the control of an operator located at an operator station that, in one embodiment, is configured as an operator seat 112. Coupling of the hand control 110 to the support platform 103 may advantageously allow the hand control 110 to move together with the support platform 103 and thus move together with the operator sitting in the operator seat 112 on the support platform 103, which may provide a more comfortable riding and operating experience. In alternative embodiments, the hand control 110 may be coupled to the operator seat 112, to a seat frame 111 as discussed further herein, or to any other element operatively coupled to the support platform 103 that moves together with the support platform. Via incremental pivoting, the hand controls 110 are operable to proportionally control the speed and rotational direction of their respective drive wheels, effectively controlling the propulsion and steering of the vehicle 100 (e.g., the left hand control 110a may control speed and rotational direction of the left drive wheel 106a, while the right hand control 110b may control speed and rotational direction of the right drive wheel 106b) via manipulation of the mower's drive system. While illustrated herein as incorporating separate hand controls 110, other controls, e.g., single or multiple joysticks or joystick-type levers, touchpads, steering wheels, foot pedals, etc. could also be used to control one or both of mower speed and direction.

An implement, e.g., lawn mower cutting deck 114, may be mounted to the lower side of the chassis 102, e.g., generally between the rear drive wheels 106 and the front wheels 108. The cutting deck 114 may include a housing forming a cutting chamber partially surrounding one or more rotatable cutting blades (not shown) as is known in the art. While shown as a mid- or belly-mount deck, other embodiments may position the deck in other locations, e.g., forward of the front wheels 108, aft of the rear wheels 106, lateral to the chassis 102, etc.

During operation, power is selectively delivered (by the prime mover) to the cutting deck 114 and the drive wheels 106, whereby the cutting blades rotate at a speed sufficient to sever grass and other vegetation as the deck passes over the ground surface 105. Typically, the cutting deck 114 has an operator-selectable height-of-cut system to allow deck height adjustment relative to the ground surface 105.

The vehicle 100 may also include one or more side shells or fenders 116 located relatively close to the operator seat. The fenders 116 provide not only storage areas for the operator, but also cover a variety of vehicle controls and components, such as the fuel tank, hand controls 110a, 110b, etc. The vehicle 100 may include a fender on both the left (fender 116a) and right (fender 116b) side of the operator seat 112 as shown in FIG. 1. The fenders 116 may be coupled to the chassis 102 or alternatively to the support platform 103, etc.

In some embodiments, the fenders are constructed of plastic (but could be made of metallic and other non-metallic materials). Each fender may include several cutouts for storage of items. For example, a cup holder may be provided on one or both of the fenders. As stated above, each fender may also accommodate a variety of machine controls, such as the drive control levers, engine throttle, ignition, PTO engagement, etc.

As illustrated in the partial view of FIG. 2, a suspension system, e.g., suspension system 200, may be operatively connected between the chassis 102 and the support platform 103. In one embodiment, the suspension system 200 includes, among other components, a first suspension apparatus 202 and, optionally, a second suspension apparatus 204.

The first suspension apparatus 202 may operatively act between the chassis 102 and the support platform 103. The first suspension apparatus 202 may include one or more springs 206, discussed further herein. The one or more springs 206 may be configured to elastically deflect when the support platform 103 is displaced relative to the chassis 102. The first suspension apparatus 202 may be longitudinally positioned (i.e., positioned along the longitudinal axis 101) at or near a rear end of the support platform 103 (e.g., at or near the seat support portion), while the second suspension apparatus 204 may be longitudinally spaced-apart from the apparatus 202 such that it is located more toward an intermediate or central portion of the support platform 103. While such placement may position the suspension apparatus 202, 204 near a center of the unsprung mass of the support platform 103, other suspension apparatus locations are also contemplated. The second suspension apparatus 204 may also operatively act between the chassis 102 and the support platform 103. The second suspension apparatus 204 may, like the apparatus 202, include one or more springs 206 configured to elastically deflect when the support platform 103 is displaced relative to the chassis 102.

While the exact placement may vary, the seat 112 is generally located mid-ship on the chassis (forward of the engine 104). One or more isolators may be provided between the seat 112 and a seat frame 111, the latter attached to the support platform 103. The isolator(s) may include elastomeric elements that absorb multidirectional forces resulting from engine and/or mower operation. Once again, while shown as a seat 112, operator stations adapted to support a standing operator are also contemplated within the scope of this disclosure.

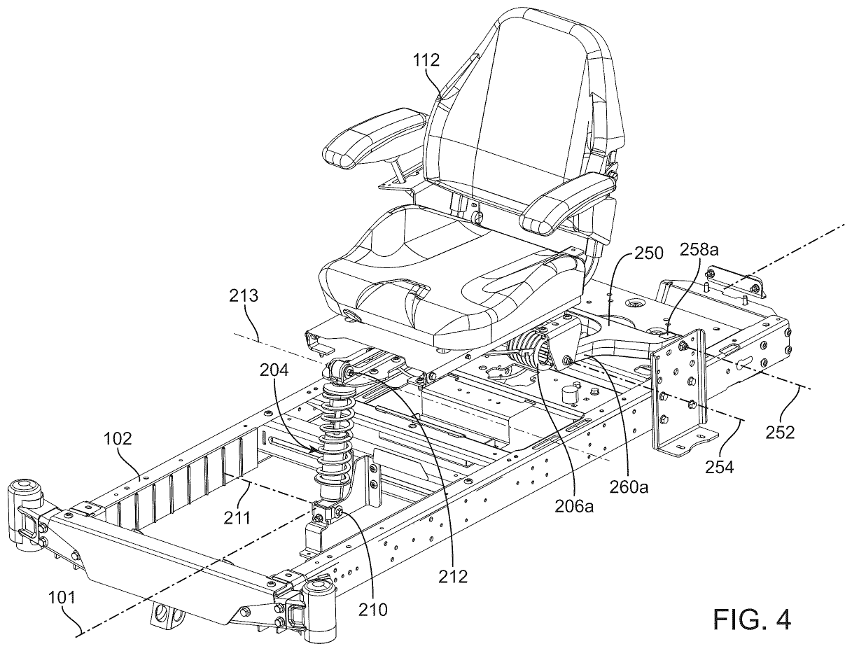

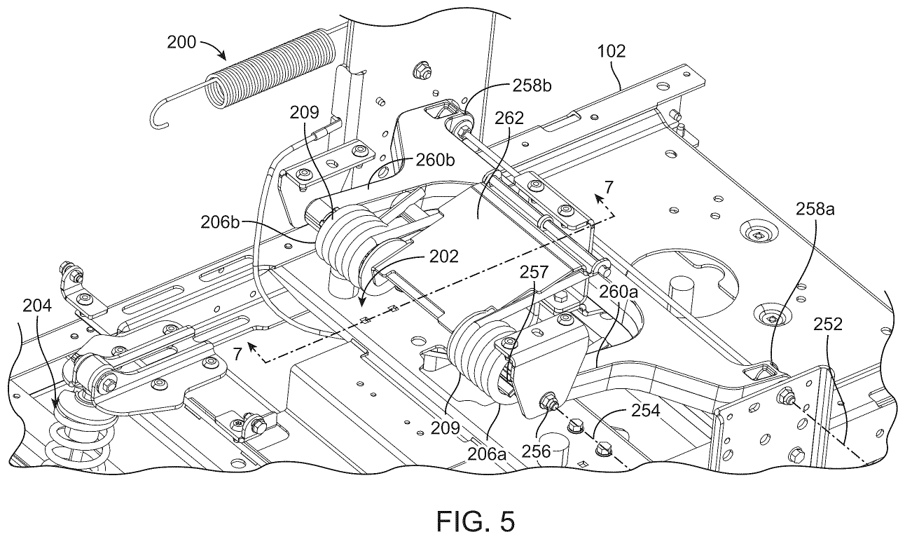

In one or more embodiments, the first suspension apparatus 202 may be formed by one or more compact-height suspension units located primarily beneath the seat elevation. For example, as shown in the partial perspective views of FIGS. 4 and 5, the suspension apparatus 202 may include first and second biasing elements (e.g., springs 206) as described in more detail below. In some embodiments, the springs 206 (e.g., the two torsion springs 206a, 206b) are spaced apart from one another in a transverse direction.

Further, the support platform 103 has a long dimension that extends along the longitudinal axis 101. In addition to a seat support portion 120 to which the seat 112 may couple, the support platform 103 may further define a foot support portion 122, and a connecting structure 124, the latter which may connect the seat support portion to the foot support portion. As shown in FIG. 2, the seat support portion 120 may form the rear end of the platform 103, while the foot support portion 122 may form the front end.

The connecting structure 124 may be a separate component of the platform 103 or, alternatively, part of one or both of the seat support portion 120 and the foot support portion 122. In general, the connecting structure 124 may be of most any configuration that connects the seat support portion 120 to the foot support portion 122 of the support platform 103. For instance, in the illustrated embodiment, the foot support portion 122 is vertically spaced-apart from (e.g., below) the seat support portion 120 and, in at least one embodiment, the foot support portion 122 and the seat support portion 120 are in generally parallel planes. As a result, the connecting structure 124 may be oriented in a direction that is generally vertical, or at an incline from vertical. Regardless of its exact orientation, the connecting structure 124 may extend from a forward end of the seat support portion 120 downwardly to a rear end of the foot support portion 122. As described and illustrated herein, the connecting structure 124, the seat support portion 120, and/or the foot support portion 122 may incorporate features (e.g., cutouts or openings) to accommodate the second suspension apparatus 204 (see FIG. 2). While the support platform 103 is shown herein as a unitary (e.g., cast or welded) structure, those of skill in the art will realize that it could also be an assembly of multiple components that are rigidly connected (e.g., bolted, welded, clamped, pinned, etc.), or otherwise attached to one another.

Although shown as being vertically spaced-apart, the seat support portion 120 and the foot support portion 122 may, in other embodiments, both be on the same plane (i.e., forming a generally flat support platform 103). In such a configuration, the connecting structure 124 is understood to be an intermediate portion of the support platform 103 that lies between the seat support portion 120 and the foot support portion 122.

In the illustrated embodiments, the suspension system 200 includes the first suspension apparatus 202 and the second suspension apparatus 204, each of which operatively supports the platform 103 relative to the chassis 102 (e.g., biases the support platform away from the chassis) as the platform moves through its range of motion. For purposes of this description, potential degrees of freedom of the platform 103/seat 112, relative to the chassis 102, may be described as occurring in relation to three mutually perpendicular axes as shown in FIG. 1: the longitudinal or fore-and-aft axis x; the transverse or side-to-side axis y; and the vertical axis z. In addition to potential translation along each of these three axes, the platform 103/seat 112 may also potentially pivot, relative to the chassis 102, about the x (e.g., “roll”), y (e.g., “pitch”), and z (e.g., “yaw”) axes.

With reference to FIG. 4, the second suspension apparatus may be configured as a coil-over shock absorber 204 that defines a front connection of the platform 103 to the chassis 102. As shown, the shock absorber 204 may be pivotally connected to the chassis 102 at a frame pivot 210 and to the platform 103 (only partially shown in FIG. 4) at a platform pivot 212. The pivots 210, 212 may define transverse, parallel axes 211, 213, respectively, about which the shock absorber 204 may pivot. Moreover, the shock absorber 204 may utilize spherical rod ends at each of the pivots 210, 212 to allow limited side-to-side translation of the platform 103 relative to the chassis 102. While shown herein as a linear shock absorber, the second suspension apparatus could be configured as most any suspension device including, for example, one or more elastomeric elements, torsion springs, extension springs, compression springs, gas-filled devices, etc. In fact, any device that is capable of providing elastic deflection could be used.

The suspension system 200 may further include a pivot member 250 that defines a rear connection of the platform 103 to the chassis 102. The pivot member 250 may assist in reducing or even eliminating fore-and-aft and transverse (side-to-side) translation, as well as rolling and yawing, of the support platform 103 relative to the chassis 102. In other words, the pivot member 250 may be configured to permit the support platform 103 to move generally up and down and pitch, while reducing or eliminating transverse and fore-and-aft translation, as well as rolling and yawing.

The pivot member 250 may define two transverse pivot axes: a first pivot axis 252 and a second pivot axis 254. The pivot member 250 may be pivotally coupled to the chassis 102 at the first pivot axis 252, and pivotally coupled to the support platform 103 at the second pivot axis 254. In the illustrated embodiment, the first and second pivot axes 252, 254 are parallel to one another and transverse to the longitudinal axis 101. The second pivot axis 254 may pivotally couple to the support platform 103 along the seat support portion 120 as shown (e.g., under the center of mass of the operator). Moreover, while illustrated with the first pivot axis 252 being located aft of the second pivot axis 254, other embodiments may place the first pivot axis forward of the second pivot axis. Additional components of the pivot member 250 (e.g., transverse lugs 258a, 258b, arms 260a, 260b, etc.) are described in U.S. Pat. No. 10,864,832.

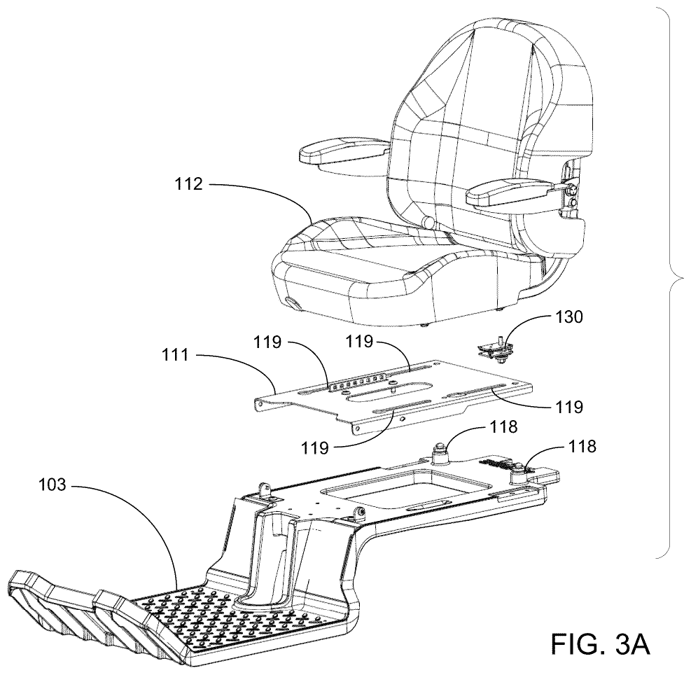

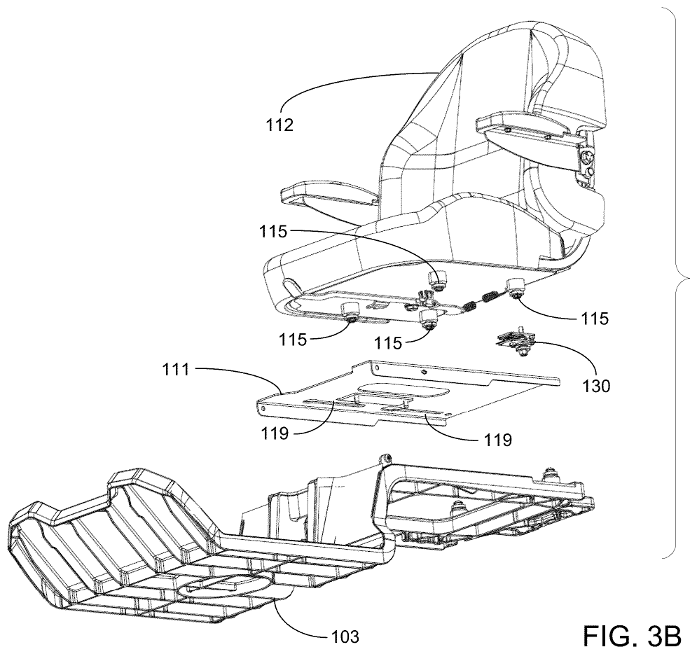

Further, the seat 112 is shown spaced apart from the seat frame 111 and the support platform 103 in FIGS. 3A and 3B to further describe the interactions therebetween. For example, in one or more embodiments, the seat frame 111 may be movably attached to the support platform 103 to, e.g., allow access underneath the seat 112 (e.g., to a portion of the support platform or an opening therethrough). Specifically, the seat frame 111 may be pivotably attached to the support platform 103 proximate a front end portion of the seat frame 111. A rear end portion of the seat frame 111 (e.g., an end spaced away from the pivot end) may move towards and away from the support platform 103 as the front end portion pivots. Other types of relative movement between the seat frame 111 and the support platform 103 are also contemplated herein such as, e.g., the rear end portion of the seat frame 111 may pivot relative to the support platform 103. In one or more alternative embodiments, the at least one hand control 110 is operatively coupled to the seat frame 111.

Further, in one or more embodiments, a damper 118 may be positioned between the seat frame 111 and the support platform 103 such that an end portion of the seat frame 111 not pivotably connected to the support platform 103 (e.g., the rear end portion) may be supported. For example, the damper 118 may be coupled to the support platform 103 and the seat frame 111 may rest on the damper 118. While FIG. 3A illustrates two dampers 118, any suitable number of dampers and locations thereof may be contemplated herein to support the seat frame 111 upon the support platform 103. Furthermore, the damper 118 may provide additional attenuation of forces felt by an operator on the seat 112.

The seat 112 may be coupled to the seat frame 111 in any suitable way. For example, the seat 112 may include one or more seat posts 115 (e.g., as shown in FIG. 3B) that are configured to be coupled to the seat frame 111 (e.g., the one or more seat posts 115 may be positioned between the seat frame 111 and the operator seat 112). In one or more embodiments, the one or more seat posts 115 of the seat 112 may be configured to be coupled to the support platform 103. For example, the one or more seat posts 115 may be positioned between the support platform 103 and the operator seat 112 to support the operator seat 112. In one or more embodiments, the seat 112 may be connected to the support platform 103 (e.g., through the seat frame 111) via the one or more seat posts 115. In other words, the one or more seat posts 115 may be supporting the entire weight of the seat 112 and any force applied to the seat 112.

In one or more embodiments (e.g., as shown in FIG. 3A), the seat frame 111 may define one or more slots 119 within which the one or more seat posts 115 are coupled. Further, the one or more seat posts 115 may be coupled within the one or more slots 119 such that the one or more seat posts 115 (and thereby the seat 112) may be movable along the one or more slots 119. Specifically, the one or more slots 119 illustrated in FIG. 3A are oriented to extend along the longitudinal axis 101 such that the seat 112 may be adjustable/movable forward and back (e.g., due to the seat posts 115 sliding along the slots 119).

Furthermore, in one or more embodiments, the vehicle 100 may include a load sensor 130 configured to measure a weight applied to the support platform 103. The load sensor 130 may include a variety of different suitable components. The load sensor 130 may be positioned at any suitable position on the vehicle 100 to measure the weight applied on the suspension system 200 through the support platform 103. In one or more embodiments, the load sensor 130 may be operatively connected to the operator seat 112 to measure the weight applied to the operator seat 112. As such, the load sensor 130 may measure any weight applied to the suspension system 200 of the vehicle, whether the weight is applied through the support platform 103 or a seat 112 coupled to the support platform.

For example, in one or more embodiments, at least one of the one or more seat posts 115 may include a load sensor 130. In some embodiments, each of the one or more seat posts 115 may include a load sensor 130. In such embodiments, the load sensor(s) 130 may measure the weight applied through the corresponding seat post 115.

The seat 112 may include any suitable number of seat posts 115 (e.g., two, three, four, etc.) and any suitable number of load sensors 130. Therefore, if every seat post 115 includes a load sensor 130, the total weight applied to the seat 112 may be measured (e.g., because the seat 112 is only connected through the seat posts 115). In other embodiments, only a subset of the seat posts 115 may include a load sensor 130 (e.g., to determine a partial or relative weight applied to the seat 112). As will be described further herein, the measured weight applied to the seat 112 may be used to modify or adjust the suspension system 200 of the vehicle 100.

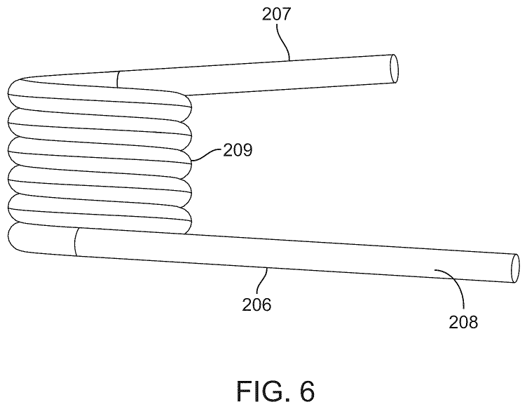

FIG. 5 illustrates a portion of the suspension system 200 with various vehicle structure removed to better illustrate the biasing elements of the first suspension apparatus 202, e.g., the springs 206. One example of the springs 206 contemplated herein includes a torsion spring, which is illustrated in isolation in FIG. 6. Each torsion spring includes a coiled body 209 and protruding legs 207 and 208. The legs 207, 208 may be generally equal in length, or may be different as shown in FIG. 6, e.g., leg 208 may be longer than leg 207. The torsion springs are adapted to elastically deflect when the support platform 103 is displaced relative to the chassis 102. Although, the present embodiment illustrates a torsion spring, any suitable biasing element may take the place of the spring 206 such as, for example, one or more elastomeric elements, extension springs, compression springs, gas-filled devices (e.g., air bags), etc. (e.g., any device that is capable of providing elastic deflection could be used).

The springs 206 (e.g., torsion springs) are positioned about a shaft 256 (via a supporting mandrel 257) extending along the second pivot axis 254 such that the coiled body 209 of each torsion spring moves with the second pivot axis 254 during operation (e.g., as shown in FIG. 5). A guide plate 262 is also pivotally attached to the shaft 256 such that it may move with the second pivot axis 254, as well as pivot about the second pivot axis 254.

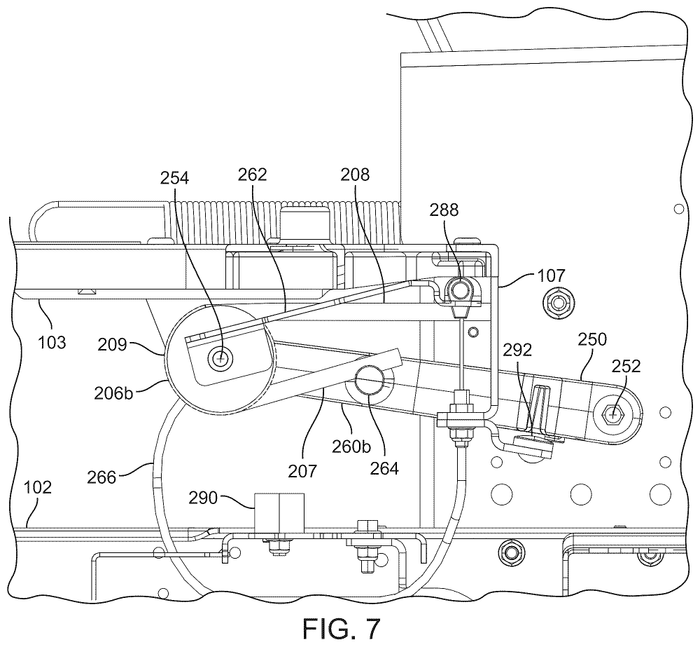

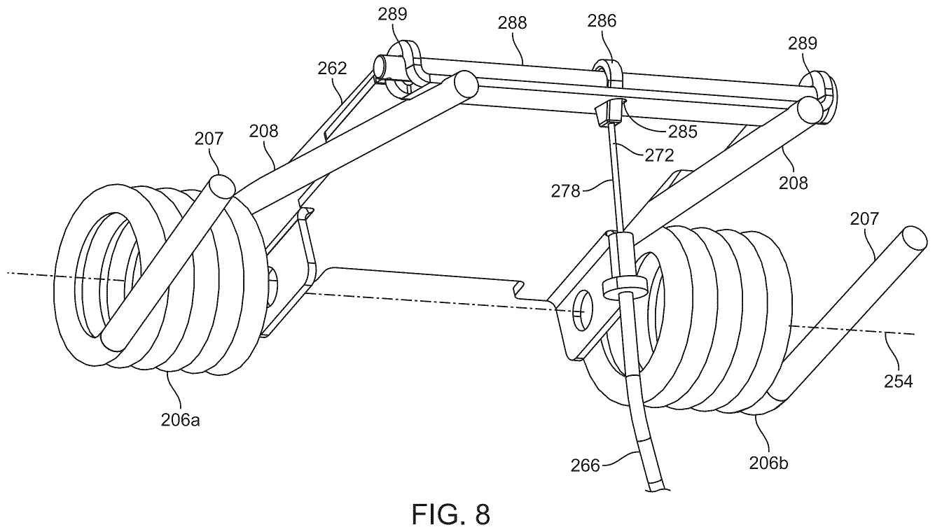

FIG. 7 illustrates a section view taken along line 7-7 of FIG. 5. As indicated in this view, the coiled body 209 of each spring 206 is secured in place along the pivot axis 254. The leg 208 may then bear directly against (abut) a load surface of either the guide plate 262 as shown (see also isolated perspective view of FIG. 8) or against a shaft 288 (described below) associated with the guide plate, while the leg 207 bears against (abuts) a receiver 264 formed along an inner face of the adjacent arm 260. Thus, the springs 206 may act directly between the shaft 288/guide plate 262 and the pivot member 250, and indirectly between the chassis 102 and the platform 103. It is noted that the spring 206 may also include any other suitable type of biasing element. For example, the spring 206 may include a coilover spring, one or more elastomeric elements, torsion springs, extension springs, compression springs, gas-filled devices, (e.g., any device that is capable of providing elastic deflection could be used), etc.

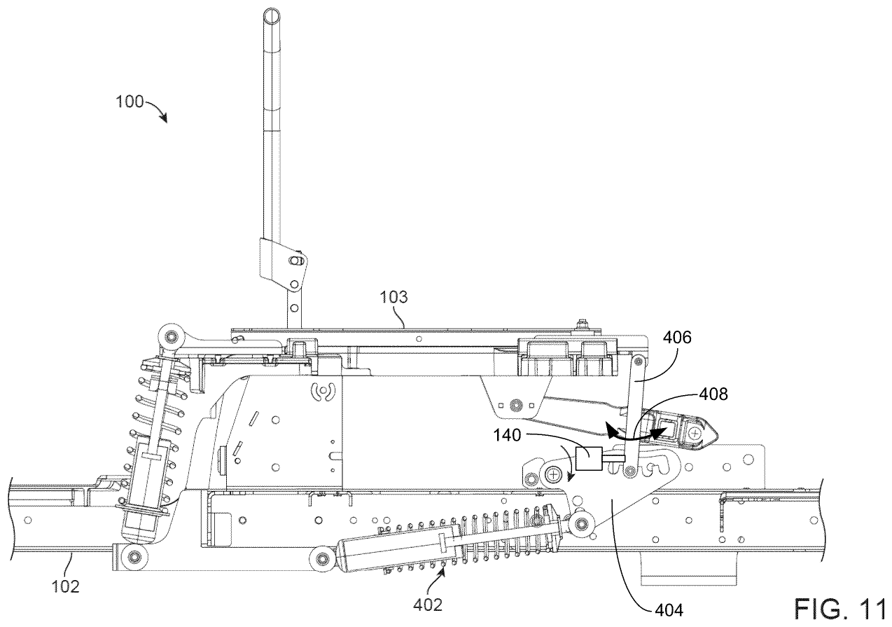

For example, FIG. 11 illustrates a generally horizontal spring 402 (e.g., a coilover spring) extending generally along the longitudinal axis (e.g., in a horizontal or approximately horizontal orientation). The generally horizontal spring 402 may be pivotally coupled to the chassis 102 and the support platform 103 to provide a suspension apparatus therebetween. In other words, a downward motion of the support platform 103 may be influenced or resisted by the generally horizontal spring 402. Furthermore, the generally horizontal spring 402 may be adjusted or loaded (e.g., preload) to alter the suspension apparatus characteristics as described herein.

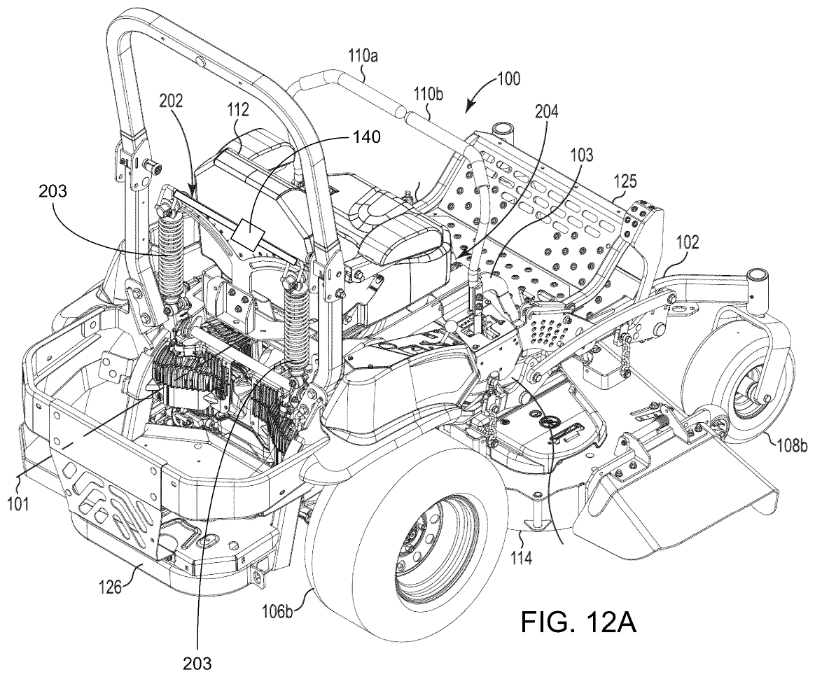

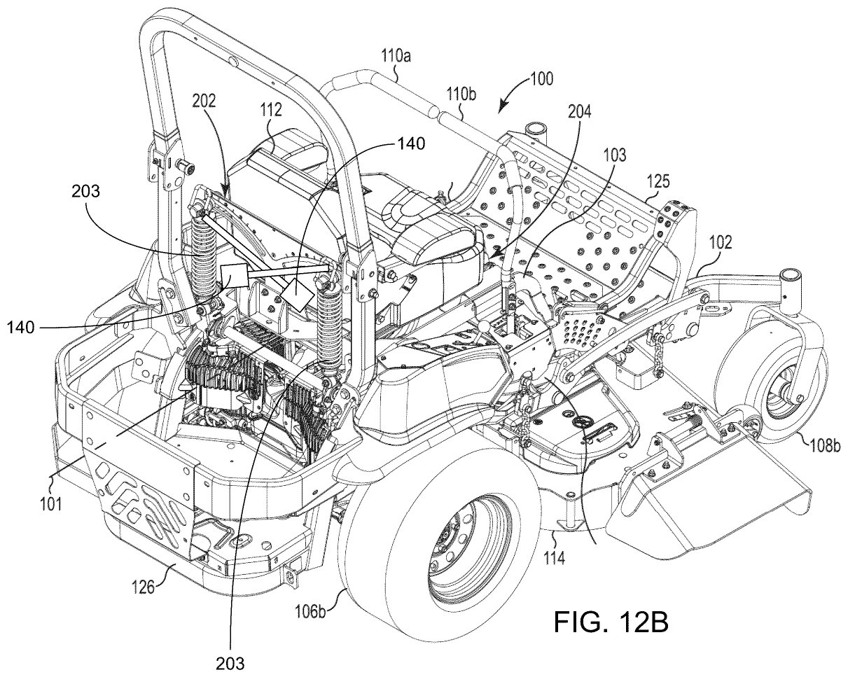

Also, for example, FIGS. 12A and 12B illustrate a suspension apparatus 202 including two suspension units 203 that may be adjustable by changing the orientation of the suspension units 203. Specifically, the suspension units having adjustable spring and damping characteristics are described in more detail in U.S. Pat. No. 9,499,204. For example, the two suspension units 203 (e.g., shock absorbers) may be laterally offset from one another and may be pivotable in a vertical plane. Further, the suspension units 203 may be adjusted or loaded (e.g., preload) to alter the suspension apparatus characteristics as described herein. It is noted that such embodiment including only one pivoting suspension unit is also contemplated herein.

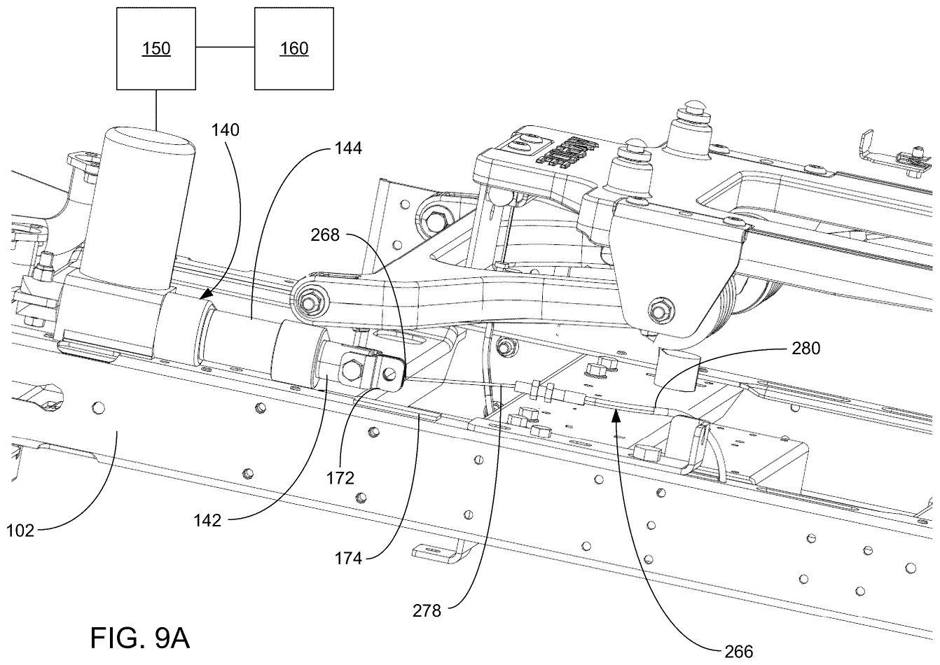

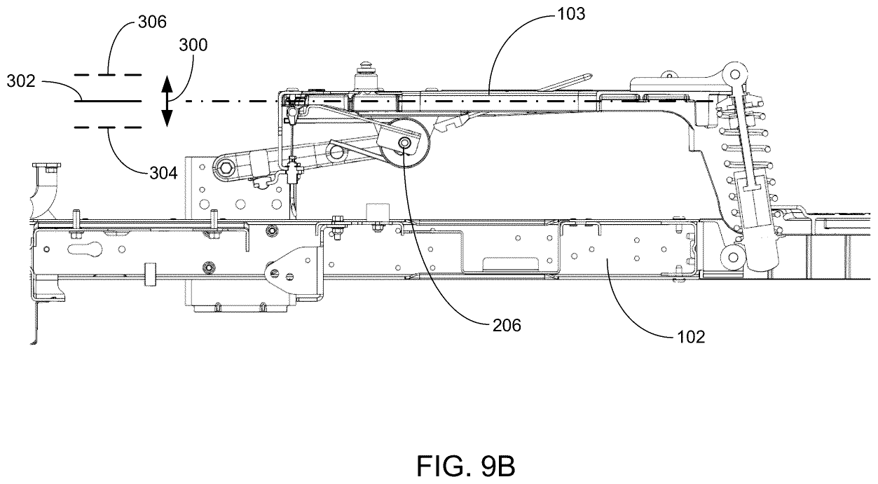

With reference to FIGS. 8 and 9A, the suspension system 200 may further include an adjustment mechanism (including, e.g., an actuator 140) that permits a load (e.g., a preload or offset load) on the one or more springs 206 to be altered, thereby changing suspension system characteristics to best satisfy the preferences of a particular operator. The adjustment mechanism or actuator 140 may apply a preload to the one or more springs in any suitable way such as, e.g., loading the spring, changing the position of the spring, changing the orientation of the spring, etc. It is noted that the one or more springs may be initially preloaded as a result of the support platform being supported on the one or more springs (and being structurally loaded thereon). Further, the preload (or additional preload) as described herein may include a load that is specifically applied to the one or more springs to set the springs in a desired loading or configuration. In other words, the preload may position the one or more springs 206 into a default position (e.g., without an operator load being applied). While the present disclosure specifically describes adjustment of the first suspension apparatus 202 (e.g., the one or more springs 206) using an actuator 140, the second suspension apparatus 204 may be similarly adjusted using the same actuator or an additional actuator.

In some embodiments, the adjustment mechanism may include a Bowden cable 266 having a first end 268 connected to an actuator 140 (e.g., as shown in FIG. 9A), and a second end 272 connected to the guide plate 262 or the shaft 288 (e.g., as shown in FIG. 8) as further described below. Such an actuator 140 may permit the action required to alter the preload to occur remotely from the springs 206. That is to say, the actuator 140 may be located at almost any location on the vehicle 100, regardless of proximity to the support platform 103. For example, the actuator 140 may be controlled at the actuator 140 or at a location remote from the actuator 140. Specifically, the actuator 140 may be controlled by a control unit spaced a distance from the actuator 140 and within easy reach of an operator when sitting on the seat 112.

The actuator 140 may be connected to the inner member 278 of the cable 266 such that when the actuator 140 moves, so does the inner member 278. The actuator 140 may be configured to move through a full range of motion between a minimum position (e.g., corresponding to the highest preload of the spring) and a maximum position (e.g., corresponding to the lowest preload of the spring). Further, an outer housing 280 of the cable 266 may have one end anchored to the chassis 102 as shown in FIG. 9A, and its opposite end anchored to a bracket 107 connected to the platform 103 as shown in FIG. 7.

The actuator 140 may include any suitable type of actuator 140 that is configured to move the inner member 278 of the cable 266. For example, the actuator 140 may include at least one of: a linear actuator, a rotational actuator, a rotary actuator, a piezoelectric inchworm motor, a hydraulic actuator, a pneumatic actuator, etc.

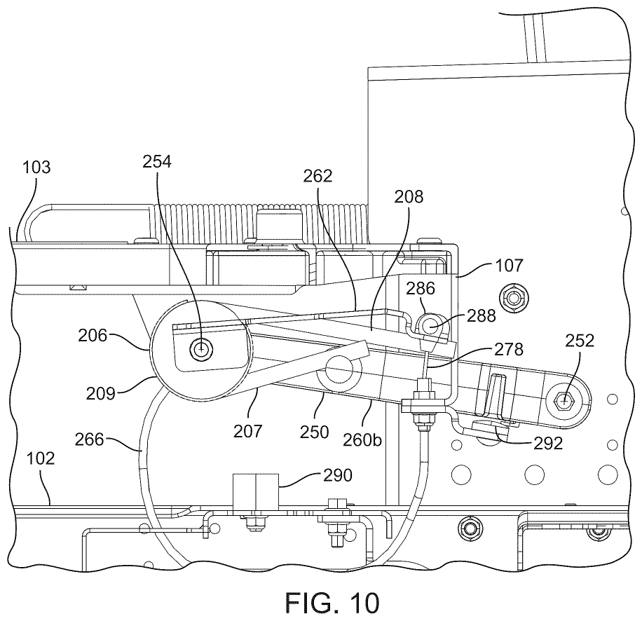

As shown in FIG. 9A, the actuator 140 may define a linear movement type actuator. For example, the actuator 140 may include a piston 142 that moves linearly relative to a housing 144 of the actuator 140. As the actuator 140 is retracted (e.g., the piston 142 moves within the housing 144), the inner member 278 may slide within the outer housing 280, displacing the shaft 288, and thus the guide plate 262, from the position shown in FIG. 7, to the position shown in FIG. 10. As the shaft 288/guide plate 262 is displaced in this direction, the legs 208 of the torsion springs (which are in operative contact with the shaft 288) are displaced, effectively twisting the coiled body 209, which in turn increases the preload on the springs 206 (e.g., simultaneously and generally equally on multiple springs, if present). Similarly, the preload on the springs 206 may be simultaneously reduced by extending the actuator 140 (e.g., as the piston 142 moves away from the housing 144).

As described herein, in one or more embodiments, the suspension apparatus may be configured as illustrated in FIG. 11. In such embodiments, the actuator 140 may be coupled to a plate 404 (e.g., which is pivotally coupled to the horizontal spring 402 and the chassis 102) and configured to move an arm 406 (e.g., which is pivotally coupled to the support platform 103) relative to the plate 404. For example, the arm 406 may move along arc 408 as the actuator 140 extends and retracts. By moving the arm 406 into different openings in the plate 404, the horizontal spring 402 may be preloaded by different amounts.

As described herein, in one or more embodiments, the suspension apparatus may be configured as illustrated in FIGS. 12A and 12B. For example, as shown in FIG. 12A, a single actuator 140 may be coupled to a vertical plate and configured to move both of the suspension units 203. Also, for example, as shown in FIG. 12B, two actuators 140 may be coupled to the vertical plate and each actuator 140 may be coupled to move one of the suspension units 203. Specifically, the suspension units 203 may move along an arched opening in the vertical plate as the actuator 140 extends and retracts. By moving the suspension units 203 along the arched openings, the suspension units may be preloaded by different amounts.

Furthermore, the vehicle 100 may include a control input 160 operatively connected to the actuator 140. The control input 160 may be configured to be manipulated by an operator to move the actuator 140 and, thereby, adjust the suspension system 200 (e.g., adjust the preload applied to the one or more springs 206). In other words, the operator may utilize a switch or control to adjust the suspension system 200 to the operator's liking. The control input 160 may be electrically connected to the actuator 140 in any suitable way including, for example, wired or wireless connections.

However, because of the electric connection (e.g., as compared to a mechanical connection), the control input 160 does not need to be rigidly attached to the actuator 140 as would be the case with manual engagement of the actuator using a mechanical lever. Therefore, the control input 160 may be located at any suitable location on the vehicle 100 (and, e.g., spaced a distance from the actuator 140) including, e.g., on the chassis 102 or on the support platform 103. For example, the control input 160 may be positioned within the convenient reach of an operator positioned on the seat 112. Further, the control input 160 may include a switch, a button, a touch screen, a dial, a slider, etc. to manipulate the actuator 140 and adjust the suspension system 200. As such, the control input 160 may provide a more accessible and usable option because the control input 160 may be located in a user friendly position on the vehicle 100 and allow for simplified interaction.

The vehicle 100 may also include a controller 150 operatively coupled to the actuator 140 and configured to move the actuator 140 to adjust the preload of the one or more springs 206. Specifically, the controller 150 may be configured to move the actuator based on one or more parameters. For example, the one or more parameters may be used to determine a specific preload of the one or more springs 206 to create a custom suspension feel for an operator supported by the seat 112 based on the one or more parameters. In other words, the controller 150 may determine a ride setting (e.g., an ideal ride setting) corresponding to the preload applied to the one or more springs 206 based on the one or more parameters.

In one or more embodiments, the controller 150 is further operatively coupled to the hand control 110. The controller 150 may be configured to adjust at least one of propulsion and steering of the vehicle 100 based on input from the hand control 110. The vehicle 100 may further include a hand control sensor (not shown) configured to detect a force applied to, or movement of, the hand control 110. The hand control sensor may be adapted to transmit an input signal to the controller 150, and the controller 150 may be adapted to transmit a command signal to one or more prime movers. The hand control sensor may be, for example, a position sensor, a force sensor, etc. The hand control sensor may be coupled to the at least one hand control 110.

The exemplary controller may include a processor that receives various inputs and executes one or more computer programs or applications stored in memory. The memory may include computer-readable instructions or applications that, when executed, e.g., by the processor, cause the controller to perform various calculations and/or issue commands. That is to say, the processor and memory may together define a computing apparatus operable to process input data and generate the desired output to one or more components/devices.

In view of the above, it will be readily apparent that the functionality of the controller may be implemented in any manner known to one skilled in the art. For instance, the memory may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While the memory and processor may be incorporated into the controller, the memory and the processor could be contained in separate modules.

The processor may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor may include multiple components, such as any combination of one or more microprocessors, one or more controllers, one or more DSPs, one or more ASICs, and/or one or more FPGAs, as well as other discrete or integrated logic circuitry. The functions attributed to the controller/processor herein may be embodied as software, firmware, hardware, or any combination thereof.

In one or more embodiments, the one or more parameters may include a measured weight via the load sensor 130 of the one or more seat posts 115 (e.g., as described in combination with FIGS. 3A and 3B). Specifically, the controller 150 may be configured to adjust the preload applied to the one or more springs 206 (e.g., by moving the actuator 140) based on the measured weight upon the operator seat 112. For example, the controller 150 may configure the ride setting to be stiffer (e.g., by increasing the preload applied to the springs) when a heavier weight is positioned on the operator seat 112 and may configure the ride setting to be less stiff (e.g., by decreasing the preload applied to the springs) when a lighter weight is positioned on the operator seat 112. It is noted that the load sensors 130 described herein are used in combination with the seat posts 115, however, load sensors may be utilized at other positions on the vehicle 100 to measure loads applied to the vehicle 100 (e.g., which may be used as one of the one or more parameters).

As such, in one or more embodiments, the controller 150 may automatically set the ride setting based on the one or more parameters. In other words, the one or more parameters may be used in real time to determine the ride setting and appropriately adjust the preload applied to the one or more springs 206. Further, in one or more embodiments, the ride setting may be calibrated for the one or more parameters (e.g., to ensure the correct seat position for the provided one or more parameters).

The ride setting may be further defined by the one or more parameters to focus on the desired suspension for an operator. The one or more parameters used to determine the ride setting may include a variety of different measured or input values. For example, the one or more parameters may include a desired ride type of an operator, a seat position, a weight of the operator, an acceleration of the vehicle 100 across a ground surface 105, an acceleration of the support platform 103 (e.g., the seat support portion 120) relative to the chassis 102, etc.

The desired ride type of an operator may include a soft, medium, or firm ride mode that may be set by the operator (e.g., using the control input 160). For example, if the operator prefers a softer suspension, the controller 150 may decrease the preload applied to the one or more springs 206 and if the operator prefers a firm suspension, the controller 150 may increase the preload applied to the one or more springs 206.

The seat position (e.g., relative to the support platform 103) may affect the feel of the suspension and, therefore, may factor into how the controller 150 is configured to move the actuator 140 to modify the preload applied to the one or more springs 206. Further, in one or more embodiments, the seat 112 may include a sensor to measure the movement or position of the seat 112 relative to the support platform 103. Therefore, in one or more embodiments, the seat 112 movement or position information may be used as one of the one or more parameters. For example, the seat position may indicate whether the weight is distributed towards the front or back. Specifically, the load sensor 130 may measure a weight in the seat 112 and the seat sensor may determine the position of the seat 112 to set the preload of the springs 206.

Similarly, a weight of the operator may affect the feel of the suspension system 200 and, therefore, may factor into how the controller 150 is configured to move the actuator 140 to modify the preload applied to the one or more springs 206. For example, in one or more embodiments, the controller 150 may compare the measured weights from multiple load sensors to determine how the operator is sitting on the seat (e.g., more weight towards the front or back of the seat) to determine the optimal preload applied to the one or more springs 206.

Additionally, the acceleration of the vehicle 100 (e.g., moving along the ground surface 105) or the acceleration of the support platform 103 relative to the chassis 102 (e.g., due to unexpected bumps) may be measured to factor into how the controller 150 may be configured to move the actuator 140 to modify the preload applied to the one or more springs 206 (e.g., an active response to acceleration and terrain as the vehicle 100 is moving).

Each of the one or more parameters may be input into the controller 150 in a variety of different ways. For example, the measured or calculated values (e.g., weight measured by the load sensors, seat position, acceleration, etc.) may be automatically input to the controller 150 to modify the suspension ride setting (e.g., the control input may be configured to be manipulated by the operator to select a ride setting). Also, for example, the desired values or parameters (e.g., the desired ride type) may be set by the operator to modify the suspension ride setting. Further, in one or more embodiments, the operator may be able to indicate which parameters are used to determine the ride setting (e.g., disabling or enabling one or more of the parameters).

Therefore, in operation, the controller 150 may be configured to adjust the preload of the one or more springs 206 (e.g., the ride setting) automatically when the operator is supported on the support platform 103 (e.g., when the operator sits on the seat 112). Further, in one or more embodiments, the controller 150 may be configured to adjust the preload applied to the one or more springs 206 based on the ride setting. Further, in one or more embodiments, the controller 150 may be configured to pre-set the ride setting based on operator input. For example, in one or more embodiments, after the one or more parameters are considered and the ride setting is set, the ride setting may be saved. Thereafter, the operator may manually select the ride setting customized to the operator (e.g., the pre-set) when operating the vehicle 100. Further, in one or more embodiments, the controller 150 may be configured to pre-set the ride setting based on a wireless communication. For example, a wireless signal (e.g., Bluetooth, Radio Frequency ID, Near Field Communication, etc.) present in a wireless communication device (e.g., a phone, a fob, a key, etc.) may be transmitted to the controller 150 and may be associated with a specific ride setting. Therefore, the operator may use the wireless communication device to automatically adjust the ride setting when the operator is operating the vehicle 100.

Additionally, the controller 150 may be configured to maintain the preload applied to the one or more springs 206 (e.g., the ride setting) for a period of time. For example, the controller 150 may maintain the ride setting for a period of time even if the operator is not supported by the support platform 103 (e.g., the ride setting may not reset each time the operator exits the vehicle 100). In other words, the ride setting may be saved for a period of time. Therefore, if the operator exits or steps off the vehicle 100 (e.g., momentarily), the ride setting may not be erased or reset when the operator returns to the vehicle 100.

For example, in one or more embodiments, the period of time for which the preload ride setting applied to the one or more springs 206 is maintained may be about 5 minutes, about 30 minutes, about 1 hour, about 24 hours, etc. Furthermore, in one or more embodiments, the period of time may be adjustable by the operator. In one or more embodiments, the vehicle 100 may include a reset button for suspension system 200 such that when the reset button is engaged, the period of time ends and the preload applied to the one or more springs 206 is no longer maintained, and the preload may be reduced or removed. Therefore, upon engagement of the reset button, the controller 150 may be configured to adjust the preload applied to the one or more springs 206 (e.g., via the actuator 140) based on the one or more parameters. However, in one or more embodiments, the preload may be saved such that when the reset button is engaged again, the most recent saved preload is selected and the controller 150 is configured to revert to the saved preload applied to the one or more springs 206.

In one or more embodiments, the period of time for which the preload applied to the one or more springs 206 is maintained may be configured to end upon turning off the vehicle 100. For example, as long as the vehicle 100 is active or on, the preload applied to the one or more springs 206 (e.g., a ride setting) may be maintained. Therefore, an operator may physically exit the vehicle 100, but as long as the vehicle 100 is on (e.g., idling), the ride setting may not be reset. Further, in one or more embodiments, when the vehicle 100 is turned off, the preload applied to the one or more springs 206 may be removed. However, in one or more embodiments, the ride setting may be saved such that when the vehicle 100 is turned back on, the most recent ride setting is reimplemented and the controller 150 is configured to revert the preload applied to the one or more springs 206.

Further, in one or more embodiments, the ride setting may be further modified or updated by the operator. For example, as described herein, the vehicle 100 may include a control input 160 that is configured to be manipulated by an operator to move the actuator 140. In one or more embodiments, after the controller 150 adjusts the preload of the one or more springs 206 based on the one or more parameters, the operator may finetune the preload to the operator's specific preferences. For example, the operator may incrementally adjust the suspension system 200 to be softer or firmer (e.g., by moving the actuator 140 to adjust the preload of the one or more springs 206). In one or more embodiments, the operator modification may become the new or updated ride setting (e.g., that is saved for a period of time as described herein). In other words, the control input 160 may be used to adjust or override the ride setting based on operator manipulation.

In one or more embodiments, the “ideal” ride setting may be determined based on a position of the seat 112 within a range of travel (e.g., a stroke) when engaging the suspension system 200 (e.g., deflecting the one or more springs). For example, the support platform 103 (e.g., upon which the seat 112 is coupled) may move relative to the chassis 102 in a variety of different ways via the suspension system 200. This movement of the support platform 103 relative to the chassis 102 defines a range of travel. The range of travel may be defined by the coupling interaction between the support platform 103 and the chassis 102, and typically is defined by a pivoting motion or vertical motion.

The actuator 140 may be configured to adjust the preload applied to the one or more springs 206 such that an operating position (e.g., an angle relative to horizontal, a vertical position, etc.) of the support platform 103 (e.g., the seat support portion 120) is maintained within the range of travel 300 (e.g., extending along an arc or vertical direction), e.g., as shown in in FIG. 9B, when under operator load. However, if, for example, the vehicle experiences uneven terrain or external forces, the operating position of the support platform 103 may move beyond, or outside of, the range of travel 300, such that the operating position of the support platform 103 is normally, but not always, maintained within the range of travel 300. Any travel outside of the range of travel 300 may be minimized such that the operating position of the support platform 103 is substantially maintained within the range of travel 300 (e.g., minimized in terms of distance outside of the range, time outside of the range, etc.). Further, in one or more embodiments, the operating position may be maintained to stay at a substantially middle position of the range of travel 300 (e.g., a middle of the stroke). In other words, when an operator is supported by the support platform 103 the one or more springs 206 may deflect a certain amount (e.g., along the range of travel 300). Under operator load, the support platform 103 may remain at an operating position somewhere within the range of travel 300 (e.g., at a minimum height, at a maximum height, or somewhere therebetween). The controller 150 may be configured to apply a preload to the one or more springs 206 (e.g., using the actuator 140) to modify the operating position such that the operating position is about in the middle (e.g., a substantially middle position 302) between the minimum elevation 304 and the maximum elevation 306 (e.g., as shown in FIG. 9B). Therefore, the one or more springs 206 may allow deflection in either direction by about the same amount (e.g., as compared to the operating position being proximate the minimum elevation and prone to bottoming out). In one or more embodiments, it may be desirable to choose an operating position that is not a substantially middle position.

The operating position of the support platform 103 may be measured in a variety of different ways. For example, a sensor may be positioned between the support platform 103 and the chassis 102 to measure the operating position. Also, in one or more embodiments, the operating position may be determined between, e.g., the seat 112 and the chassis 102, a trailing arm and the support platform 103, a trailing arm and the chassis 102, a force sensor in the spring 206 (e.g., based on known attributes of the spring 206).

In one or more embodiments, the suspension system 200 may also include an actuator sensor (not shown) operatively coupled to one or both of the actuator 140 and the chassis 102. The actuator sensor may be configured to determine a position of at least a portion of the actuator 140 relative to the chassis 102. For example, as shown in FIG. 9A, the actuator sensor may include a target 172 (e.g., a magnet) coupled to the actuator 140 and a detector 174 (e.g., a magnetic sensor) coupled to the chassis 102. The sensor may be configured to determine a position (e.g., linear or rotational position) of a portion of the actuator 140 relative to the chassis 102. The controller 150 may utilize the actuator position information to track the adjustments made by an operator (e.g., using a control input 160) or made automatically. Further, the controller 150 may utilize the actuator position information to store different preloads applied to the one or more springs 206 that correspond with a ride setting.

FIG. 8 illustrates attachment of the cable 266, e.g., the inner member 278, to the shaft 288/guide plate 262. In this embodiment, the plate may include an opening 285 through which a cable eye 286 (attached to second end 272 of the inner member 278) may pass. The eye 286 may include an aperture adapted to receive the shaft 288 that is itself engaged with the guide plate by passing through openings 289 formed on the top of the guide plate. The opening 285 allows pivoting of the eye 286 about the shaft 288 as the shaft 288/guide plate 262 moves through its range of motion (see, e.g., FIGS. 7 and 10). As one can appreciate, the guide plate 262 may be used merely to stabilize the shaft 288. That is to say, the adjustment mechanism (i.e., the cable 266) may not even require the guide plate 262. However, use of the guide plate 262 may ensure that the shaft 288 does not shift out of place during operation.

To limit travel of the support platform 103 relative to the chassis 102, stops 290 and 292 may be provided as shown in FIG. 10. The stop 290 (one located under each arm 260a, 260b) may limit downward movement of the platform 103 by contacting the arms 260 of the pivot member 250, while the stop 292 (attached to the bracket 107) may limit upward movement of the platform upon contact with the pivot member. In the illustrated embodiments, the stops 290, 292 are formed of a resilient, compressible material such as rubber (e.g., neoprene) to effectively reduce hard, jarring impacts at the travel extremes of the platform 103.

Some examples of the present disclosure are recited below.

Example 1. A grounds maintenance vehicle including: a chassis including a front end, a rear end, and a longitudinal axis extending between the front and rear ends. The vehicle further includes a support platform extending along the longitudinal axis. The vehicle further includes at least one hand control carried by the support platform and configured to control at least one of propulsion and steering of the vehicle. The vehicle further includes a suspension system including: a first suspension apparatus operatively acting between the chassis and the support platform, where the first suspension apparatus includes one or more springs, and where the one or more springs are configured to elastically deflect when the support platform is displaced relative to the chassis. The suspension system further includes an actuator configured to adjust a preload applied to the one or more springs. The vehicle further includes a load sensor configured to measure a weight applied to the support platform. The vehicle further includes a controller operatively coupled to the actuator and configured to adjust the actuator to modify the preload based on the weight measured by the load sensor.

Example 2. The grounds maintenance vehicle of Example 1, wherein the controller is further operatively coupled to the at least one hand control and configured to adjust the at least one of propulsion and steering of the vehicle based on the at least one hand control.

Example 3. The grounds maintenance vehicle of any of Examples 1-2, wherein the at least one hand control comprises: a first hand control operable to control a speed and rotational direction of a left side drive member; and a second hand control operable to control a speed and rotational direction of a right side drive member.

Example 4. The grounds maintenance vehicle of any of Examples 1-3, further comprising a hand control sensor configured to detect a force applied to, or movement of, the at least one hand control.

Example 5. The grounds maintenance vehicle of Example 4, wherein the hand control sensor is adapted to transmit an input signal to the controller, and wherein the controller is adapted to transmit a command signal to one or more prime movers.

Example 6. The grounds maintenance vehicle of any of Examples 1-5, wherein the support platform comprises a seat support portion supporting an operator seat, wherein the load sensor is operatively connected to the operator seat.

Example 7. The grounds maintenance vehicle of Example 6, further comprising one or more seat posts positioned between the support platform and the operator seat, wherein at least one of the one or more seat posts comprises the load sensor.

Example 8. The grounds maintenance vehicle of any of Examples 1-7, wherein the actuator is configured to adjust the preload based upon one or more parameters comprising at least one of: a desired ride type; a seat position; a weight of an operator; an acceleration of the vehicle; and an acceleration of the support platform relative to the chassis.

Example 9. The grounds maintenance vehicle of any of Examples 1-8, further comprising a control input operatively connected to the controller, wherein the control input is configured to be manipulated by an operator to select a ride setting.

Example 10. The grounds maintenance vehicle of Example 9, wherein the controller is configured to adjust the preload applied to the one or more springs based upon the ride setting.

Example 11. The grounds maintenance vehicle of any of Examples 1-10, wherein the controller is configured to maintain the preload applied to the one or more springs until either the vehicle is turned off or a reset button is engaged, and wherein the controller is further configured to revert to the preload applied to the one or more springs when the vehicle is turned back on or when the reset button is engaged again.

Example 12. The grounds maintenance vehicle of any of Examples 1-11, wherein the actuator is configured to adjust the preload applied to the one or more springs to maintain an operating position of the support platform within a range of travel.

Example 13. The grounds maintenance vehicle of any of Examples 1-12, wherein the actuator comprises at least one of: a linear actuator and a rotary actuator.

Example 14. The grounds maintenance vehicle of any of Examples 1-13, further comprising a second suspension apparatus longitudinally spaced-apart from the one or more springs, the second suspension apparatus operatively connected to both the support platform and the chassis.

Example 15. The grounds maintenance vehicle of any of Examples 1-14, wherein the suspension system further comprises an actuator sensor operatively coupled to one or both of the actuator and the chassis, and wherein the actuator sensor is configured to determine a position of at least a portion of the actuator relative to the chassis.

Example 16. The grounds maintenance vehicle of Example 15, wherein the actuator sensor comprises a target coupled to the actuator and a detector coupled to the chassis.

Example 17. A grounds maintenance vehicle including: a chassis including a front end, a rear end, and a longitudinal axis extending between the front and rear ends. The vehicle further includes a support platform extending along the longitudinal axis, where the support platform is positioned at an operating position under operator load. The vehicle further includes at least one hand control carried by the support platform and configured to control at least one of propulsion and steering of the vehicle. The vehicle further includes a suspension system including: a first suspension apparatus operatively acting between the chassis and the support platform, where the first suspension apparatus comprises one or more springs, and wherein the one or more springs are configured to elastically deflect when the support platform is displaced relative to the chassis. The suspension apparatus further includes an actuator configured to adjust a preload applied to the one or more springs. The vehicle further includes a controller operatively coupled to the actuator and configured to move the actuator to adjust the preload to maintain the operating position of the support platform within a range of travel.

Example 18. The grounds maintenance vehicle of Example 17, wherein the controller is further operatively coupled to the at least one hand control and configured to control the at least one of propulsion and steering of the vehicle based on manipulation of the at least one hand control.

Example 19. The grounds maintenance vehicle of any of Examples 17-18, wherein the at least one hand control comprises: a first hand control operable to control a speed and rotational direction of a left side drive member; and a second hand control operable to control a speed and rotational direction of a right side drive member.

Example 20. The grounds maintenance vehicle of any of Examples 17-19, further comprising a hand control sensor configured to detect a force applied to, or movement of, the at least one hand control.

Example 21. The grounds maintenance vehicle of Example 20, wherein the hand control sensor is adapted to transmit an input signal to the controller, and wherein the controller is adapted to transmit a command signal to one or more prime movers.

Example 22. The grounds maintenance vehicle of any of Examples 17-21, wherein the support platform comprises a seat support portion supporting an operator seat.

Example 23. The grounds maintenance vehicle of any of Examples 17-22, wherein the actuator is configured to adjust the preload based upon one or more parameters comprising at least one of: a desired ride type; a seat position; a weight of an operator; an acceleration of the vehicle; and an acceleration of the support platform relative to the chassis.

Example 24. The grounds maintenance vehicle of any of Examples 17-23, further comprising a control input operatively connected to the controller, wherein the control input is configured to be manipulated by an operator to select a ride setting.

Example 25. The grounds maintenance vehicle of Example 24, wherein the controller is configured to adjust the preload applied to the one or more springs based upon the ride setting.

Example 26. The grounds maintenance vehicle of any of Examples 17-25, wherein the controller is configured to maintain the preload applied to the one or more springs until either the vehicle is turned off or a reset button is engaged, and wherein the controller is further configured to revert to the preload applied to the one or more springs upon turning the vehicle back on or upon engagement of the reset button again.

Example 27. The grounds maintenance vehicle of any of Examples 17-26, wherein the suspension system further comprises an actuator sensor operatively coupled to one or both of the actuator and the chassis, and wherein the actuator sensor is configured to determine a position of at least a portion of the actuator relative to the chassis.

Example 28. The grounds maintenance vehicle of Example 27, wherein the actuator sensor comprises a target coupled to the actuator and a detector coupled to the chassis.

Example 29. The grounds maintenance vehicle of any of Examples 17-28, further comprising a second suspension apparatus longitudinally spaced-apart from the one or more springs, the second suspension apparatus operatively connected to both the support platform and the chassis.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

1. A grounds maintenance vehicle comprising:
a chassis comprising a front end, a rear end, and a longitudinal axis extending between the front and rear ends;
a support platform extending along the longitudinal axis;
at least one hand control carried by the support platform and configured to control at least one of propulsion and steering of the vehicle;
a suspension system comprising:
a first suspension apparatus operatively acting between the chassis and the support platform, wherein the first suspension apparatus comprises one or more springs, and wherein the one or more springs are configured to elastically deflect when the support platform is displaced relative to the chassis; and
an actuator configured to adjust a preload applied to the one or more springs;
a load sensor configured to measure a weight applied to the support platform; and
a controller operatively coupled to the actuator and configured to adjust the actuator to modify the preload based on the weight measured by the load sensor.

2. The grounds maintenance vehicle of claim 1, wherein the controller is further operatively coupled to the at least one hand control and configured to adjust the at least one of propulsion and steering of the vehicle based on the at least one hand control.

3. The grounds maintenance vehicle of claim 1, wherein the at least one hand control comprises: a first hand control operable to control a speed and rotational direction of a left side drive member; and a second hand control operable to control a speed and rotational direction of a right side drive member.

4. The grounds maintenance vehicle of claim 1, further comprising a hand control sensor configured to detect a force applied to, or movement of, the at least one hand control.

5. The grounds maintenance vehicle of claim 4, wherein the hand control sensor is adapted to transmit an input signal to the controller, and wherein the controller is adapted to transmit a command signal to one or more prime movers.

6. The grounds maintenance vehicle of claim 1, wherein the support platform comprises a seat support portion supporting an operator seat, wherein the load sensor is operatively connected to the operator seat.

7. The grounds maintenance vehicle of claim 6, further comprising one or more seat posts positioned between the support platform and the operator seat, wherein at least one of the one or more seat posts comprises the load sensor.

8. The grounds maintenance vehicle of claim 1, wherein the actuator is configured to adjust the preload based upon one or more parameters comprising at least one of: a desired ride type; a seat position; a weight of an operator; an acceleration of the vehicle; and an acceleration of the support platform relative to the chassis.

9. The grounds maintenance vehicle of claim 1, further comprising a control input operatively connected to the controller, wherein the control input is configured to be manipulated by an operator to select a ride setting.

10. The grounds maintenance vehicle of claim 9, wherein the controller is configured to adjust the preload applied to the one or more springs based upon the ride setting.

11. The grounds maintenance vehicle of claim 1, wherein the controller is configured to maintain the preload applied to the one or more springs until either the vehicle is turned off or a reset button is engaged, and wherein the controller is further configured to revert to the preload applied to the one or more springs when the vehicle is turned back on or when the reset button is engaged again.

12. The grounds maintenance vehicle of claim 1, wherein the actuator is configured to adjust the preload applied to the one or more springs to maintain an operating position of the support platform within a range of travel.

13. The grounds maintenance vehicle of claim 1, wherein the actuator comprises at least one of: a linear actuator and a rotary actuator.

14. The grounds maintenance vehicle of claim 1, further comprising a second suspension apparatus longitudinally spaced-apart from the one or more springs, the second suspension apparatus operatively connected to both the support platform and the chassis.

15. The grounds maintenance vehicle of claim 1, wherein the suspension system further comprises an actuator sensor operatively coupled to one or both of the actuator and the chassis, and wherein the actuator sensor is configured to determine a position of at least a portion of the actuator relative to the chassis.

16. The grounds maintenance vehicle of claim 15, wherein the actuator sensor comprises a target coupled to the actuator and a detector coupled to the chassis.

17. A grounds maintenance vehicle comprising:
a chassis comprising a front end, a rear end, and a longitudinal axis extending between the front and rear ends;
a support platform extending along the longitudinal axis, wherein the support platform is positioned at an operating position under operator load;
at least one hand control carried by the support platform and configured to control at least one of propulsion and steering of the vehicle;
a suspension system comprising:
a first suspension apparatus operatively acting between the chassis and the support platform, wherein the first suspension apparatus comprises one or more springs, and wherein the one or more springs are configured to elastically deflect when the support platform is displaced relative to the chassis; and
an actuator configured to adjust a preload applied to the one or more springs; and
a controller operatively coupled to the actuator and configured to move the actuator to adjust the preload to maintain the operating position of the support platform within a range of travel.

18. The grounds maintenance vehicle of claim 17, wherein the controller is further operatively coupled to the at least one hand control and configured to control the at least one of propulsion and steering of the vehicle based on manipulation of the at least one hand control.

19. The grounds maintenance vehicle of claim 17, wherein the at least one hand control comprises: a first hand control operable to control a speed and rotational direction of a left side drive member; and a second hand control operable to control a speed and rotational direction of a right side drive member.

20. The grounds maintenance vehicle of claim 17, further comprising a hand control sensor configured to detect a force applied to, or movement of, the at least one hand control.

21. The grounds maintenance vehicle of claim 20, wherein the hand control sensor is adapted to transmit an input signal to the controller, and wherein the controller is adapted to transmit a command signal to one or more prime movers.

22. The grounds maintenance vehicle of claim 17, wherein the support platform comprises a seat support portion supporting an operator seat.

23. The grounds maintenance vehicle of claim 17, wherein the actuator is configured to adjust the preload based upon one or more parameters comprising at least one of: a desired ride type; a seat position; a weight of an operator; an acceleration of the vehicle; and an acceleration of the support platform relative to the chassis.

24. The grounds maintenance vehicle of claim 17, further comprising a control input operatively connected to the controller, wherein the control input is configured to be manipulated by an operator to select a ride setting.

25. The grounds maintenance vehicle of claim 24, wherein the controller is configured to adjust the preload applied to the one or more springs based upon the ride setting.

26. The grounds maintenance vehicle of claim 17, wherein the controller is configured to maintain the preload applied to the one or more springs until either the vehicle is turned off or a reset button is engaged, and wherein the controller is further configured to revert to the preload applied to the one or more springs upon turning the vehicle back on or upon engagement of the reset button again.

27. The grounds maintenance vehicle of claim 17, wherein the suspension system further comprises an actuator sensor operatively coupled to one or both of the actuator and the chassis, and wherein the actuator sensor is configured to determine a position of at least a portion of the actuator relative to the chassis.

28. The grounds maintenance vehicle of claim 27, wherein the actuator sensor comprises a target coupled to the actuator and a detector coupled to the chassis.

29. The grounds maintenance vehicle of claim 17, further comprising a second suspension apparatus longitudinally spaced-apart from the one or more springs, the second suspension apparatus operatively connected to both the support platform and the chassis.
